(19) United States
(12) Patent Application Publication
(10) Pub. No.: US 2008/0028679 A1
(43) Pub. Date: Feb. 7, 2008

(54) Plant pot drainage system

(76) Inventors: Margaret Anderson, Medford, NJ (US); N. Eric Anderson, Medford, NJ (US)

Correspondence Address: Hollstein Keating Cattell Johnson & Goldstein P.C.;Willow Ridge Executive Office Park, Suite 301, 750 Route 73 South, Marlton, NJ, 08053, US

(21) Appl. No.: 11/497,197

(22) Filed: Aug. 1, 2006

(51) Int. Cl. A01G 9/02

(52) U.S. Cl. 47/80

(57) ABSTRACT

A plant pot drainage system has a pot or planter-type container with potting soil. Lightweight, non-mineral rock shaped filler elements are located in the lower section of the container. The elements are irregular in shape, allowing the potting soil to fill spaces between the elements. This promotes drainage and proper root growth within the container. The elements are formed from synthetic, crush-proof material, for example high strength plastic, and can be hollow, to enhance the lightweight nature of the elements. Use of these filler elements ensures that the planted container can be easily lifted and readily transported.

### BACKGROUND OF THE INVENTION

Landscapes, plantscapers, and professional and amateur gardeners alike all are well aware of the advantages of placing rocks, stones or other natural mineral material in the bottoms of plant and flower containers, such as planters and pots, to promote drainage within the containers. While such drainage systems are beneficial, use of rocks and stones add significant weight to planted soil-filled containers. Medium to large pots and planters, even the lightweight ones, many of which are made of plastic or other synthetic material, can weigh more than 100 pounds when filed with potting soil, rocks, and the plant itself. The use of ceramic pots adds even more weight. Eliminating the rocks and filling a pot with all soil will lighten the pot somewhat. However, the use of soil alone greatly inhibits drainage within the pot, restricting moisture to plant roots, causing them to rot and the plants to eventually die.

### SUMMARY OF THE INVENTION

It is thus the object of the present invention to provide a plant pot drainage system which overcomes the disadvantages and limitations of prior systems.

It is an object of the present invention to provide a plant pot drainage system which is relatively lightweight, yet effective in allowing proper drainage for the plant in the system's pot or planter container.

It is another object of the present invention to provide a plant pot drainage system which uses a pot or planter container with lightweight, non-mineral rock shaped filler elements, not only to promote drainage through the system, but also to allow ease of lifting and transporting the container.

It is a further object of the present invention to provide a plant pot drainage system which uses a pot or planter container lightweight, non-mineral rock shaped filler elements of irregular shape which allows soil in the container to fill spaces between the filler elements to promote proper root growth and a more balanced container.

These and other advices and advantages are accomplished by the present invention, a plant pot drainage system which comprises a pot or planter-type container with potting soil. Lightweight, non-mineral rock shaped filler elements are located in the lower section of the container. The elements are irregular in shape, allowing the potting soil to fill spaces between the elements. This promotes drainage and proper root growth within the container. The elements are formed from synthetic, crush-proof material, for example high strength plastic, and can be hollow, to enhance the lightweight nature of the elements. Use of these filler elements ensures that the planted container can be easily lifted and readily transported.

Novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### DETAILED DESCRIPTION OF THE INVENTION

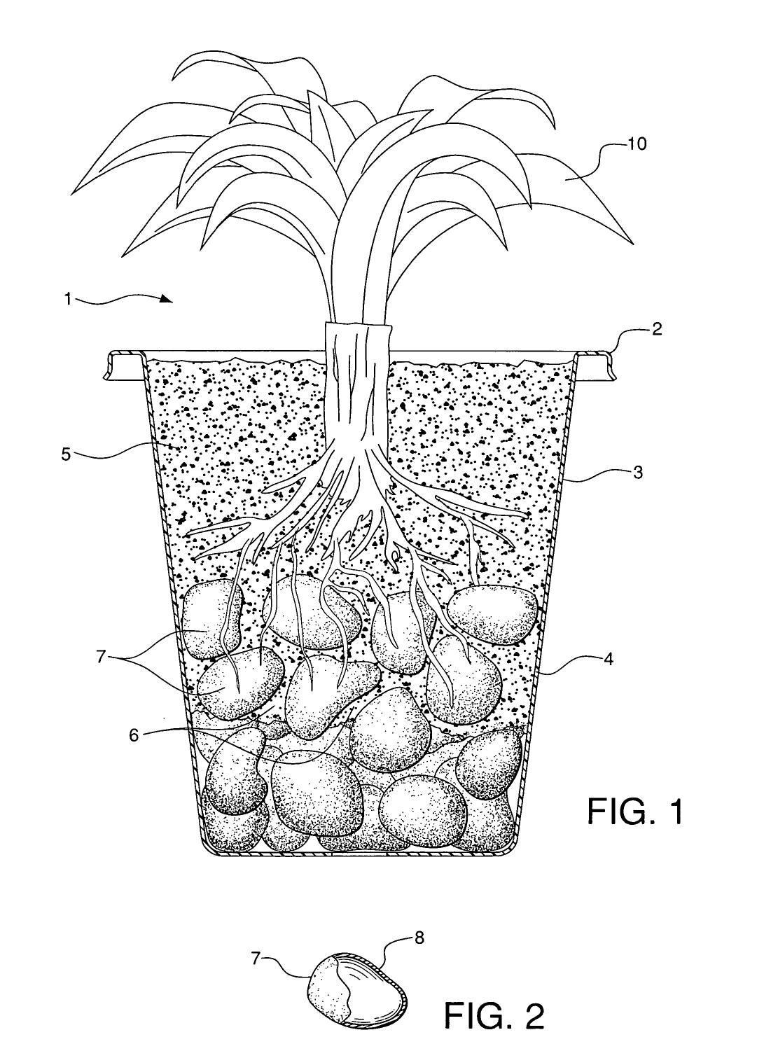

FIG. 1 shows a cross-sectional view of the plant pot drainage system of the present invention.

FIG. 2 shows a partial cross-sectional view of a filler element of the present invention.

### DETAILED DESCRIPTION OF THE INVENTION

Plant pot drainage system 1 comprises container or planter or flower pot 2. As shown in FIG. 1, pot 2 has an upper section 3 and a lower section 4. Pot 2 contains a quantity of potting soil 5. A plurality of manufactured filler elements 7 are positioned within lower section 4 of pot 2.

Filler elements 7 are rock shaped in configuration and are irregular in shape. This creates spaces 6 between filler elements 7, which allow some of the soil 5 to enter the spaces between the elements. Filler elements 7 are specifically intended to be lightweight and certainly much lighter than natural mineral rocks of the same size. Towards that end, it is anticipated that filler elements 7 will be formed from lightweight synthetic material, such as the various well known self-supporting, relatively high bearing strength, crush-proof, plastics, like urethane, or their equivalents. However, the invention is not to be considered restricted to the material used in the manufacture of filler elements 7. The material used need only be lightweight and have the high-strength characteristics previously described. To ensure for their light weight, filler elements 7, as shown in FIG. 2, optimally will be hollow, surrounded by a high strength outer layer 8. Outer layer 8 will be formed to give the appearance of a natural rock.

In use, filler rocks 7 are positioned within lower section 4 of pot 2. Potted plant 10 is planted within and extends from potting soil 5. As discussed previously, soil 5 also fills spaces 6 between filler elements 7. This provides an environment for excellent drainage within lower section 4 of pot 2, which allows roots 12 to spread into spaces 6, promoting healthy root growth.

Most significant, use of lightweight filler elements 7 in system 1 vastly reduces the weight of the potted planter or pot 2. Pot 2, with plant 10, soil 5 and all filler elements 7, will be less than half the weight of pot drainage systems which use approximately the same number of natural mineral rocks of the same shape. Pot 2 with filler elements 7 is easy to lift and is easily transportable, with the weight of the pot, soil and plants still sufficient enough to maintain the pot upright, even outdoors.

Certain novel features and components of this invention are disclosed in detail in order to make the invention clear in at least one form thereof. However, it is to clearly understood that the invention as disclosed is not necessarily limited to the exact form and details as disclosed, since it is apparent that various modifications and changes may be made without departing from the spirit of the invention.

1. A pot plant drainage system comprising:
container means for accepting and maintaining at least one plant, said container means having up upper section and lower section;
a given quantity of soil located in the container means;
a plurality of manufactured rock shaped filler elements located in the lower section of the container means, a portion of the quantity of soil being located between the filler elements, each filler element being composed of a lightweight, non-mineral containing synthetic material and each filler element generally giving the appearance of natural, mineral rock.

2. The plant pot drainage system as in claim 1 wherein each filler element is irregular in shape.

3. The plant pot drainage system as in claim 1 wherein each filler element is hollow, with an outer layer.

4. The plant pot drainage system as in claim 1 wherein each filler element is made of lightweight plastic material.

5. A plant pot drainage system comprising:
container means for accepting and maintaining at least one plant, said container means having an upper section and lower section;
a given quantity of soil located in the container means;
a plurality of lightweight, plastic rock shaped filler elements located in the lower section of the container means, a portion of the quantity of soil being located between the filler elements, each filler element being three dimensional and hollow and each generally giving the appearance of natural mineral rock.

6. The plant pot drainage system as in claim 5 wherein each filler element is irregular in shape.

7. A plant pot drainage system comprising:
container means for accepting and maintaining at least one plant, said container means having an upper section and lower section;
a given quantity of soil located in the container means;
a plurality of rock shaped filler elements located in the lower section of the container means, a portion of the soil being located between the filler elements, each filler element being composed of a lightweight synthetic material, each filler element generally giving the appearance of natural mineral rock.

8. A plant pot drainage system as is container 7 wherein each filler element is hollow.

9. A plant pot drainage system as in claim 7 wherein each filler element is irregular in shape.

10. The plant pot drainage system as in claim 7 wherein the synthetic material is a plastic material.
